(19) United States
(12) Patent Application Publication
(10) Pub. No.: US 2016/0114806 A1
(43) Pub. Date: Apr. 28, 2016

(54) SAFE DRIVING MONITORING SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHAN-JIA AO, Wuhan (CN); JIAN-HUNG HUNG, New Taipei (TW)

(21) Appl. No.: 14/546,690

(22) Filed: Nov. 18, 2014

(30) Foreign Application Priority Data
Oct. 22, 2014 (CN) 201410565393.0

(51) Int. Cl. B60W 40/09; G06K 9/00; H04N 7/18; B60Q 9/00; B60R 1/00

(52) U.S. Cl. CPC B60W 40/09; B60Q 9/00; B60R 1/00; H04N 7/183; G06K 9/00845; G06K 9/00791

(57) ABSTRACT

A safe driving monitoring system includes a face capturing module, a face indentifying and analyzing module and an warning module. The face capturing module is configured to capture images of a driver. The indentifying and analyzing module is configured to identify the eyes of the driver and analyze if the eyes are closed based on the captured images, and send an abnormal driver signal when the eyes are closed longer then a preset time value. The warning module is configured to warn the driver of an abnormal driving behavior according to the abnormal driver signal. The disclosed subject matter also provides a safe driving monitoring method.

### CROSS-REFERENCE TO RELATED APPLICATIONS

This application claims priority to Chinese Patent Application No. 201410565393.0, filed on Oct. 22, 2014, the contents of which are incorporated by reference herein.

### FIELD

The present disclosure relates to a safe driving monitoring system and method.

### BACKGROUND

As more people drive more cars, the number of accidents increase proportionally. Driving fatigue is a major cause of accidents.

### BRIEF DESCRIPTION OF THE DRAWINGS

Implementations of the present technology will now be described, by way of example only, with reference to the attached figures.

FIG. 1 is a block diagram of a safe driving monitoring system.

FIG. 2 is a flowchart of a safe driving monitoring method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

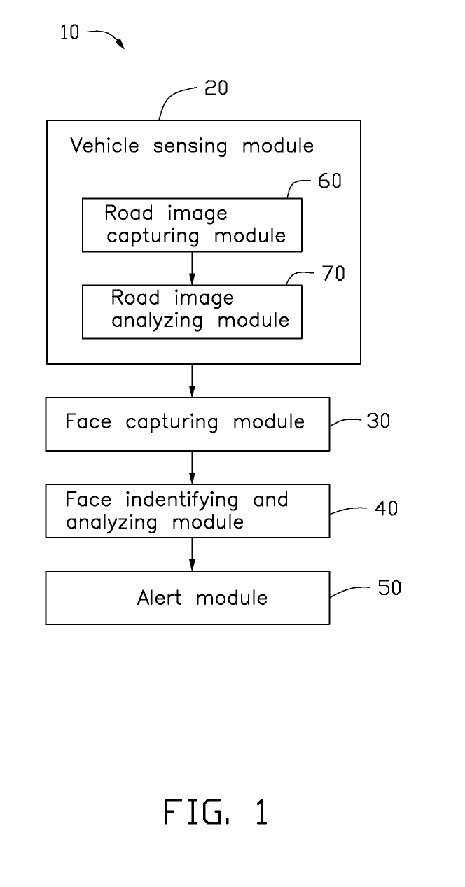

FIG. 1 illustrates a safe driving monitoring system 10. The safe driving monitoring system 10 is employed in a motor vehicle to warn a driver if experiencing an abnormal driving behavior. The safe driving monitoring system 10 includes a vehicle sensing module 20, a face capturing module 30, a face indentifying and analyzing module 40 and a warning module 50.

The vehicle sensing module 20 is configured to sense whether the motor vehicle is moving and send a movement signal to the face capturing module 30 when the motor vehicle is moving. In the embodiment, the vehicle sending module 20 includes a road image capturing module 60 and a road image analyzing module 70. The road image capturing module 60 is configured to continuously capture images of a road in front of the motor vehicle and send the captured images of the road to the road image analyzing module 70. The road image analyzing module 70 is configured to compare the captured images of the road, if the captured images of the road are different, it determines that the motor vehicle is moving. The road image analyzing module 70 is further configured to send the movement signal to the face capturing module 30 if the captured images of the road are different.

The face capturing module 30 is positioned before the driver. The face capturing module 30 is configured to continuously capture images of the driver according to the movement signal. The image of the driver includes the face of the driver. The face indentifying and analyzing module 40 is configured to indentify the face of the driver and analyze whether an orientation of the face is in a normal range. In an embodiment, the normal range is that the head rotates from 45 degrees to the left to 45 degrees to the right relative to the neck of the driver. The face indentifying and analyzing module 40 is further configured to send an abnormal driver signal to the warning module 50 when the orientation of the face is in an abnormal range, and identify the eyes of the driver and analyze a state of the eyes of the driver when the orientation of the face is in the normal range and send an abnormal driver signal to the warning module 50 when the eyes are closed for a period of time exceeding a preset time. In the embodiment, the preset time is two seconds.

The warning module 50 is configured to warn the driver of an abnormal driving behavior according to the abnormal driver signal. In at least one embodiment, the warning module 50 includes an audio warning device. The audio warning device makes a warning sound to warn the driver. In another embodiment, the warning module 50 includes a display for displaying a flashing warning to warn the driver.

In the embodiment, the face capturing module 30, the face indentifying and analyzing module 40, the warning module 50, the road image capturing module 60 and the road image analyzing module 70 are integrated in a mobile phone. The road image capturing module 60 is a rear camera of the mobile phone. The face capturing module 30 is a front-facing camera of the mobile phone. The face indentifying and analyzing module 40 and the road image analyzing module 70 are image processing software installed in the mobile phone.

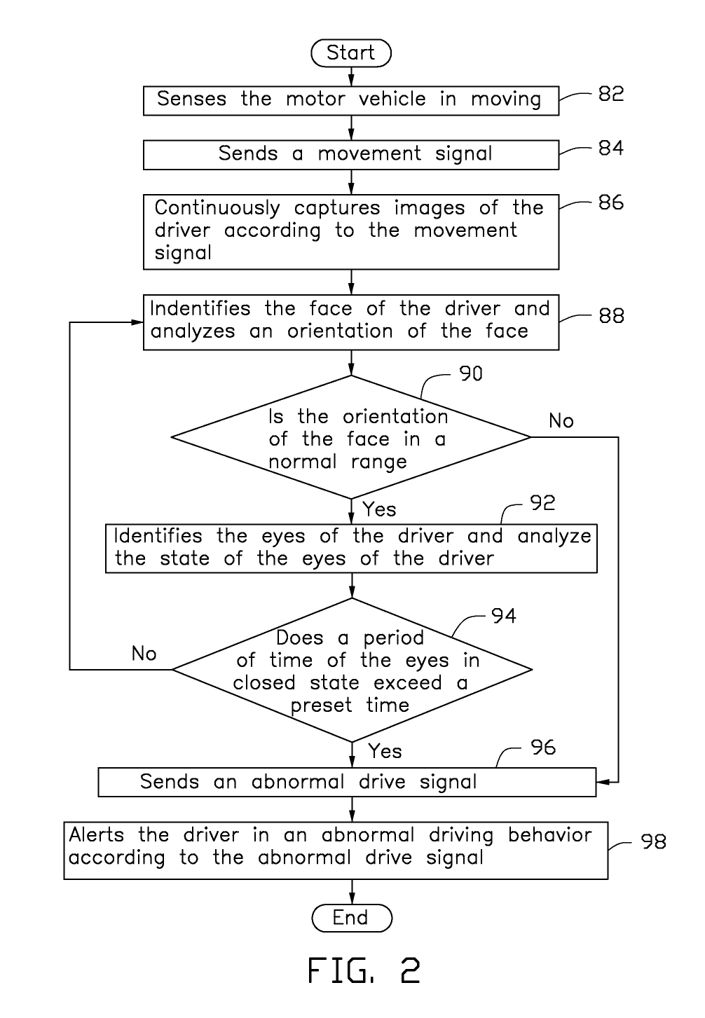

FIG. 2 illustrates a flowchart of a safe driving monitoring method. The method includes the following blocks. In block 82, the vehicle sensing module 20 senses the motor vehicle is moving. In the embodiment, the vehicle sensing module 20 continuously captures images of a road in front of the motor vehicle and compares the captured images of the road, and determines the motor vehicle is moving when the captured images of the road are different. The images of the road are captured by a rear camera of a mobile phone positioned in front of the driver.

In block 84, the vehicle sensing module 20 sends a movement signal.

In block 86, the road image capturing module 60 continuously captures images of the driver according to the movement signal. In the embodiment, the images of the road are captured by a front-facing camera of the mobile phone positioned in front of the driver.

In block 88, the face indentifying and analyzing module 40 indentifies the face of the driver and analyzes an orientation of the face.

In block 90, the face indentifying and analyzing module 40 determines whether the orientation of the face is in a normal range. In an embodiment, the normal range is the head rotating from 45 degrees to the left to 45 degrees to the right in relation to the neck of the driver. If the orientation of the face is in the normal range, the procedure goes block 92, otherwise, the procedure goes block 96.

In block 92, the face indentifying and analyzing module 40 identifies the eyes of the driver and analyzes the state of the eyes of the driver.

In block 96, the face indentifying and analyzing module 40 sends an abnormal drive signal.

In block 94, the face indentifying and analyzing module 40 determine whether the eyes are closed exceeding a preset time. If the eyes are closed exceeding the preset time, the procedure goes block 96, otherwise, the procedure goes block 88. In the embodiment, the preset time is two seconds.

In block 98, the warning module 50 warns the driver of an abnormal driving behavior according to the abnormal driver signal. In at least one embodiment, the warning module 50 makes a warning sound to warn the driver. In another embodiment, the warning module 50 displays a flashing warn subtitle to warn the driver.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. A safe driving monitoring system employed in a motor vehicle, the safety driving monitoring system comprising:
a face capturing module configured to capture images of a driver, the image of the driver comprising the face of the driver;
a face indentifying and analyzing module configured to indentify the eyes of the driver and analyze states of the eyes of the driver according to the captured images of the driver, and send an abnormal drive signal when the eyes are in a closed state for a period of time exceeding a preset time; and
an warning module configured to warn the driver in an abnormal driving behavior according to the abnormal drive signal.

2. The safe driving monitoring system as claimed in claim 1, wherein the face indentifying and analyzing module is further configured to indentify the face of the driver and analyze whether an orientation of the face is in a normal range, when the orientation of the face is in the normal range, the face indentifying and analyzing module indentifies the eyes of the driver and analyzes states of the eyes of the driver.

3. The safe driving monitoring system as claimed in claim 2, wherein if the orientation of the face is not in the normal range, the face indentifying and analyzing module sends an abnormal drive signal.

4. The safe driving monitoring system as claimed in claim 2, wherein the normal range is that the head rotates from 45 degrees to the left to 45 degrees to right relative to the neck of the driver.

5. The safe driving monitoring system as claimed in claim 1, further comprising a vehicle sensing module, the vehicle sensing module configured to sense whether the motor vehicle is moving and send a movement signal to the face capturing module when the motor vehicle is moving, the face capturing module captures the images of the driver according to the movement signal.

6. The safe driving monitoring system as claimed in claim 5, wherein the vehicle sending module comprises a road image capturing module and a road image analyzing module, the road image capturing module is configured to continuously capture images of a road in front of the motor vehicle, the road image analyzing module is configured to analyze whether the captured images of the road are same and send the movement signal to the face capturing module if the captured images of the road are different.

7. The safe driving monitoring system as claimed in claim 6, wherein the road image capturing module is a rear camera of a mobile phone.

8. The safe driving monitoring system as claimed in claim 7, wherein the face capturing module is a front-facing camera of the mobile phone.

9. The safe driving monitoring system as claimed in claim 8, wherein the face indentifying and analyzing module and the road image analyzing module are image processing software in the mobile phone.

10. The safe driving monitoring system as claimed in claim 1, wherein the preset time is two seconds.

11. The safe driving monitoring system as claimed in claim 1, wherein the warning module comprises a voice warn device, the voice warn device makes a warning sound to warn the driver.

12. The safe driving monitoring system as claimed in claim 1, wherein the warning module comprises a display for displaying a flashing warning subtitle to warn the driver.

13. A safe driving monitoring method employed in a motor vehicle, the safe driving monitoring method comprising:
capturing images of a driver, the image of the driver comprising the face of the driver;
indentifying the eyes of the driver and analyzing states of the eyes of the driver according to the captured images of the driver, and sending an abnormal drive signal when the eyes are in a closed state for a period of time exceeding a preset time; and
warning the driver in an abnormal driving behavior according to the abnormal drive signal.

14. The safe driving monitoring method as claimed in claim 13, further comprising:
indentifying the face of the driver and analyzing whether an orientation of the face is in a normal range; and
indentifying the eyes of the driver and analyzing states of the eyes of the driver when the orientation of the face is in the normal range.

15. The safe driving monitoring method as claimed in claim 14, further comprising:
sending an abnormal drive signal if the orientation of the face is not in the normal range.

16. The safe driving monitoring method as claimed in claim 14, wherein the normal range is that the head rotates from 45 degrees to the left to 45 degrees to right relative to the neck of the driver.

17. The safe driving monitoring method as claimed in claim 13, further comprising:
sensing whether the motor vehicle is moving;
capturing the images of the driver when the motor vehicle is moving.

18. The safe driving monitoring method as claimed in claim 17, wherein the block “sensing whether the motor vehicle is moving” further comprises:
capturing images of a road in front of the motor vehicle and analyzing whether the captured images of the road are same; and
determining the motor vehicle is moving when the captured images of the road are different.

19. The safe driving monitoring method as claimed in claim 13, wherein the preset time is two seconds.

20. The safe driving monitoring method as claimed in claim 13, wherein warning the driver in an abnormal driving behavior comprises making a warning sound.
